(19) United States
(12) Patent Application Publication
(10) Pub. No.: US 2009/0234623 A1
(43) Pub. Date: Sep. 17, 2009

(54) VALIDATING FIELD DATA

(75) Inventors: OLIVIER GERMAIN, Houston, TX (US); Gregory Joseph Hamman, Sugar Land, TX (US); Kristopher Givens, Katy, TX (US); Paola Alexandra Clavijo Moreno, Houston, TX (US)

Correspondence Address: SCHLUMBERGER INFORMATION SOLUTIONS, 5599 SAN FELIPE, SUITE 1700, HOUSTON, TX, 77056-2722, US

(73) Assignee: SCHLUMBERGER TECHNOLOGY CORPORATION, Houston, TX (US)

(21) Appl. No.: 12/371,699

(22) Filed: Feb. 16, 2009

Related U.S. Application Data
(60) Provisional application No. 61/035,991, filed on Mar. 12, 2008.

(51) Int. Cl. G06G 7/48

(52) U.S. Cl. 703/6

(57) ABSTRACT

An example method for validating field data associated with a field having a plurality of wellsites. The method includes obtaining a validation policy associated with the field, the validation policy including a business validity rule, a trend validity rule, and a contextual validity rule for verifying the field data based on field operation guidelines. The method further includes receiving the field data associated with the field. The method further includes, prior to storing the field data for use in a field operation, evaluating the field data using the validation policy, identifying a failure of the field data during the evaluation to comply with the validation policy, generating, using the failure, a set of invalid data that violates at least the field operation guidelines, and generating a notification of the failure. The method further includes presenting the notification of the failure and the set of invalid data.

### CROSS-REFERENCE TO RELATED APPLICATIONS

This application claims priority pursuant to 35 U.S.C. §119(e) to U.S. Provisional Patent Application No. 61/035,991 (Attorney Docket No. 94.0157; 09469/159001) entitled “System and Method For Performing Oilfield Drilling Operations,” filed Mar. 12, 2008 in the names of Olivier Germain, Greg Hamman, Kris Givens, and Paola Clavijo Moreno, the disclosure of which is incorporated by reference herein in its entirety.

### BACKGROUND

Geographic formations are often analyzed to determine the presence of subterranean assets, such as valuable fluids or minerals. Fields include numerous wellsites, which extract subterranean assets from the geographic formations. Fields are developed within these geographic formations using field operations, such as surveying, drilling, wireline testing, completions, production, planning, and analysis. Information (e.g., data) collected from both field operations and geographic formations is used to assess the underground formations, and this information is used to drive field operations to locate and, if applicable, extract the desired subterranean assets. Such data may be static or dynamic. Data may be collected and used for current or future operations. When used for future operations at the same or other locations, such data may be referred to as historical data.

Data from one or more wellbores may be analyzed to plan or predict various outcomes at a given wellbore. There are usually a large number of variables and large quantities of data to consider in analyzing a field and operations related to the field. It is, therefore, often useful to model the behavior of the field operation to determine a desired course of action. During the ongoing operations, the operating parameters may need adjustment as conditions change and new information is received. In addition, some models perform a predictive function by showing expected results if certain conditions are imposed on, or occur within, a formation.

Data may be entered into one or more modeling systems manually and/or automatically. The data may need to be valid to ensure the modeling systems generate accurate and useful outputs. Rapid data validation saves time, reduces mistakes, and expedites decisions to be made with regard to a field and/or operations related to the field.

### SUMMARY

An example method for validating field data associated with a field having a plurality of wellsites. The method includes obtaining a validation policy associated with the field, the validation policy including a business validity rule, a trend validity rule, and a contextual validity rule for verifying the field data based on field operation guidelines. The method further includes receiving the field data associated with the field. The method still further includes, prior to storing the field data for use in a field operation, evaluating the field data using the validation policy, identifying a failure of the field data during the evaluation to comply with the validation policy, generating, using the failure, a set of invalid data that violates at least the field operation guidelines, and generating a notification of the failure. The method further includes presenting the notification of the failure and the set of invalid data.

Other aspects will be apparent from the following description and the appended claims.

### BRIEF DESCRIPTION OF THE DRAWINGS

So that the above recited features can be understood in detail, a more particular description, briefly summarized above, may be had by reference to the embodiments thereof that are illustrated in the appended drawings. It is to be noted, however, that the appended drawings illustrate only some embodiments and are therefore not to be considered limiting of its scope, for this disclosure may admit to other equally effective embodiments.

FIG. 1 illustrates a schematic view, partially in cross-section, of a field having a plurality of data acquisition tools positioned at various locations along the field for collecting data from the subterranean formation, in which embodiments of validating field data may be implemented.

FIG. 2 illustrates a schematic view, partially in cross-section, of a drilling operation for a field, such as the field of FIG. 1, in which embodiments of validating field data may be implemented.

FIG. 3 illustrates an example system in which embodiments of validating field data may be implemented.

FIG. 4 illustrates a schematic view depicting a contour map for presenting field data in accordance with one or more embodiments.

FIG. 5 illustrates an example method for validating field data in accordance with one or more embodiments.

FIG. 6 illustrates an example method for performing an evaluation of the field data using a validation policy in accordance with one or more embodiments.

FIG. 7 illustrates an example method for validating field data values submitted in a blank data entry field of a data entry interface in accordance with one or more embodiments.

FIG. 8 illustrates an example method for validating field data values submitted via selection of field data values from a list of catalogued field data values in accordance with one or more embodiments.

FIG. 9 illustrates an example method for generating a notification to alert selected personnel of the existence of invalid field data values in accordance with one or more embodiments.

FIG. 10 illustrates an example method for performing a global validation of flagged field data values in accordance with one or more embodiments.

FIG. 11 illustrates an example method for planning a wellsite operation using historical field data in accordance with one or more embodiments.

FIG. 12 illustrates a computer system in which one or more embodiments of validating field data may be implemented.

### DETAILED DESCRIPTION

Embodiments are shown in the above-identified figures and described in detail below. In describing the embodiments, like or identical reference numerals are used to identify common or similar elements. The figures are not necessarily to scale and certain features and certain views of the figures may be shown exaggerated in scale or in schematic in the interest of clarity and conciseness.

The systems and methods provided may relate to acquisition of hydrocarbons from a field having numerous wellsites. It will be appreciated that the same systems and methods may also be used for performing subsurface operations, such as mining, water retrieval, and acquisition of other underground materials.

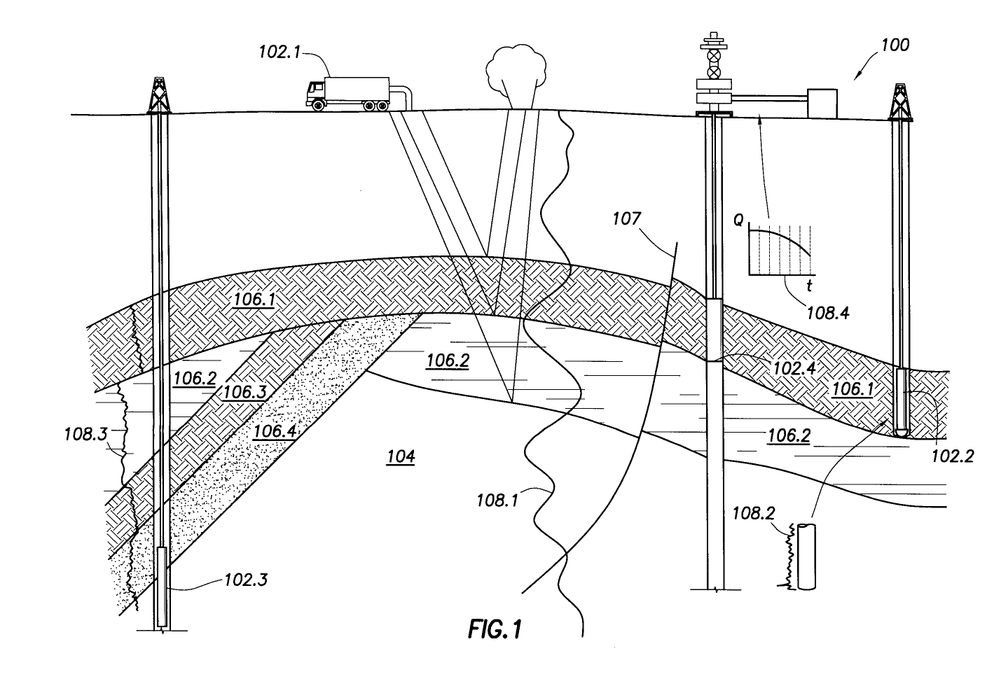

FIG. 1 is a schematic view, partially in cross section of field 100 having data acquisition tools 102.1, 102.2, 102.3 and 102.4 positioned at various locations along the field 100 for collecting data of the subterranean formation 104. Data acquisition tools 102.1 to 102.4 may be a seismic truck with geophones, drilling tools, wireline tools, and production tools, respectively, or others not depicted. As shown, data acquisition tools 102.1 to 102.4 generate data plots or measurements 108.1 to 108.4, respectively. These data plots are depicted along the field to demonstrate the data generated by the various operations.

Data plots 108.1 to 108.3 are examples of static data plots that may be generated by data acquisition tools 102.1 to 102.3, respectively. Static data plot 108.1 is a seismic two-way response time. Static plot 108.2 is core sample data measured from a core sample of the subterranean formation 104. Static data plot 108.3 is a logging trace. Production decline curve or graph 108.4 is a dynamic data plot of the fluid flow rate over time. Other data may also be collected, such as historical data, user inputs, economic information, and/or other measurement data and other parameters of interest.

Subterranean structure 104 has a plurality of geological formations 106.1 to 106.4. As shown, this structure has several formations or layers, including shale layer 106.1, carbonate layer 106.2, shale layer 106.3, and sand layer 106.4. Fault 107 extends through shale layer 106.1 and carbonate layer 106.2. The static data acquisition tools may be adapted to take measurements and detect characteristics of the formations.

While a specific subterranean formation 104 with specific geological structures is depicted, it will be appreciated that the field 100 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in the field 100, it will be appreciated that one or more types of measurement may be taken at one or more locations across one or more fields or other locations for comparison and/or analysis.

The data collected from various sources, such as the data acquisition tools of FIG. 1, may then be processed and/or evaluated. Typically, seismic data displayed in static data plot 108.1 from data acquisition tool 102.1 is used by a geophysicist to determine characteristics of the subterranean formations and features. Core data shown in static plot 108.2 and/or log data from well log 108.3 are typically used by a geologist to determine various characteristics of the subterranean formation. Production data from graph 108.4 is typically used by the reservoir engineer to determine fluid flow reservoir characteristics. The data analyzed by the geologist, geophysicist and the reservoir engineer may be analyzed using modeling techniques.

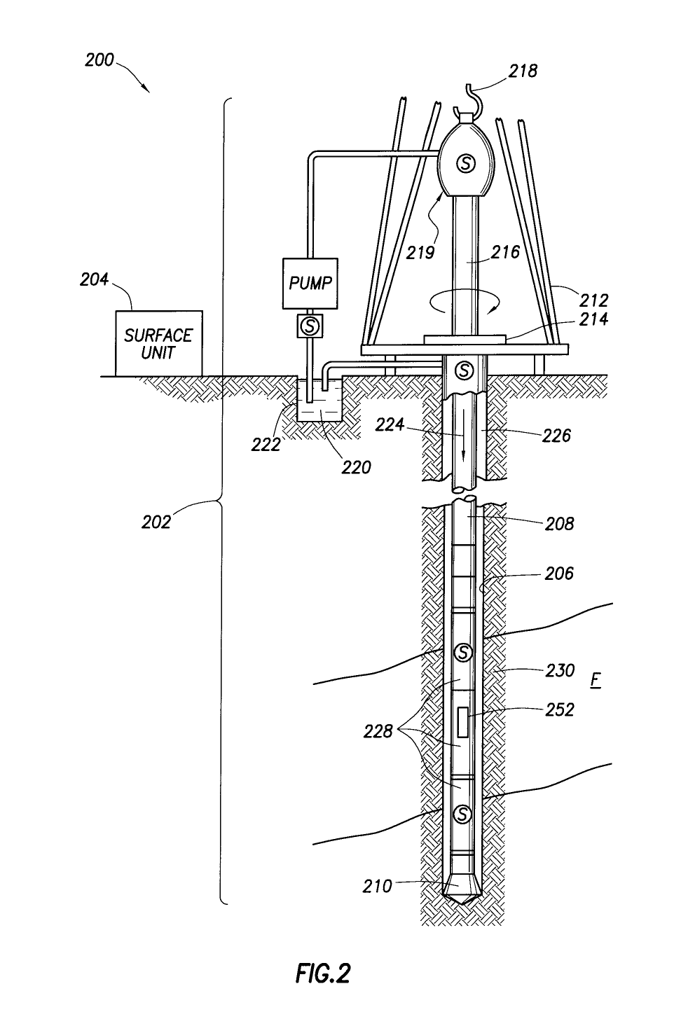

FIG. 2 is a schematic view of wellsite 200 depicting a drilling operation of a field in detail. Wellsite 200 includes drilling system 202 and surface unit 204. In the illustrated embodiment, borehole 206 is formed by rotary drilling in a manner that is well known. Those of ordinary skill in the art given the benefit of this disclosure will appreciate, however, that validating field data also finds application in drilling applications other than conventional rotary drilling (e.g., mud-motor based directional drilling), and is not limited to land-based rigs.

Drilling system 202 includes drill string 208 suspended within borehole 206 with drill bit 210 at its lower end. Drilling system 202 also includes the land-based platform and derrick assembly 212 positioned over borehole 206 penetrating subsurface formation F. Assembly 212 includes rotary table 214, kelly 216, hook 218, and rotary swivel 219. The drill string 208 is rotated by rotary table 214, energized by means not shown, which engages kelly 216 at the upper end of the drill string. Drill string 208 is suspended from hook 218, attached to a traveling block (also not shown), through kelly 216 and rotary swivel 219 which permits rotation of the drill string 208 relative to the hook 218.

Drilling system 202 further includes drilling fluid or mud 220 stored in pit 222 formed at the wellsite 200. Pump 224 delivers drilling fluid 220 to the interior of drill string 208 via a port in swivel 219, inducing the drilling fluid to flow downwardly through drill string 208 as indicated by directional arrow 224. The drilling fluid exits drill string 208 via ports in drill bit 210, and then circulates upwardly through the region between the outside of drill string 208 and the wall of borehole 206, called annulus 226. In this manner, drilling fluid lubricates drill bit 210 and carries formation cuttings up to the surface as it is returned to pit 222 for recirculation.

Drill string 208 further includes bottom hole assembly (BHA) 230, generally referenced, near drill bit 210 (in other words, within several drill collar lengths from the drill bit). Bottom hole assembly 230 includes capabilities for measuring, processing, and storing information, as well as communicating with surface unit 204. Bottom hole assembly 230 further includes drill collars 228 for performing various other measurement functions.

Sensors (S) are located about wellsite 200 to collect data concerning the operation of wellsite 200, as well as conditions at wellsite 200. Sensors (S) may have features or capabilities of monitors, such as cameras (not shown), to provide pictures of the operation. Sensors (S), which may include surface sensors or gauges, may be deployed about the surface systems to provide information about surface unit 204, such as standpipe pressure, hookload, depth, surface torque, and rotary rpm, among others. In addition, sensors (S), which include downhole sensors or gauges, are disposed about the drilling tool and/or wellbore to provide information about downhole conditions, such as wellbore pressure, weight on bit, torque on bit, direction, inclination, collar rpm, tool temperature, annular temperature and toolface, among others. The information collected by the sensors (S) and cameras is conveyed to the various parts of the drilling system and/or the surface control unit.

Drilling system 202 is operatively connected to surface unit 204 for communication therewith. Bottom hole assembly 230 is provided with communication subassembly 252 that communicates with surface unit 204. Communication subassembly 252 is adapted to send signals to and receive signals from the surface using mud pulse telemetry. Communication subassembly 252 may include, for example, a transmitter that generates a signal, such as an acoustic or electromagnetic signal, which is representative of the measured drilling parameters. Communication between the downhole and surface systems is depicted as being mud pulse telemetry. It will be appreciated by one of skill in the art that a variety of telemetry systems may be employed, such as wired drill pipe, electromagnetic or other known telemetry systems.

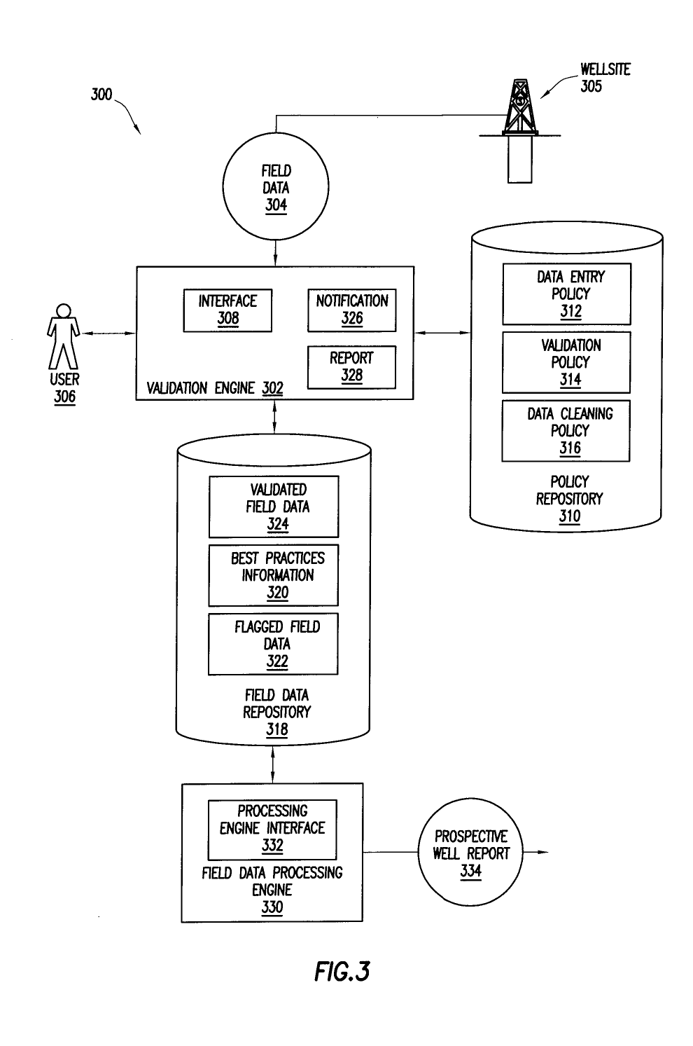

Personnel including, but not limited to, a wellsite operator, a supervisor, or other employee or contractor may be present at the wellsite 200. The personnel may, for example, maintain equipment, direct operations, observe field and operational conditions, collect and enter field data, and perform other functions related to the development and/or production of the field. For example, a mud logging engineer may collect field data related to mud logging activities (such as temperature and chlorides), where the information collected is recorded manually. In this example, once an appropriate amount of field data is collected from the mud logging activities, the mud logging engineer may manually enter the information using a data processing system. In another example, a drilling engineer may manually track the size of drill pipe used at various depths of the field during a drilling operation. In this case, the drilling engineer may manually enter a pipe size and a length of pipe corresponding to the pipe size using a data processing system. An interface for capturing manually entered field data from personnel (e.g., users) and the computer (e.g., validation engine) is described in more detail below with respect to FIG. 3.

Typically, the wellbore is drilled according to a drilling plan that is established prior to drilling. The drilling plan typically sets forth equipment, pressures, trajectories and/or other parameters that define the drilling process for the wellsite 200. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected.

FIG. 3 illustrates a schematic diagram depicting a system for processing field data in accordance with one or more embodiments. As shown in FIG. 3, the data processing system 300 includes a validation engine 302, a policy repository 310, a field data repository 318, and a field data processing engine 330. The validation engine 302 includes an interface 308, a notification 326, and a report 328. The policy repository 310 includes a data entry policy 312, a validation policy 314, and a data cleaning policy 316. The field data repository 318 includes validated field data 324, best practices information 320, and flagged field data 322. The field data processing engine 330 includes a processing engine interface 332. The data processing system 300 interacts with, and is operatively connected to, a user 306 and field data 304. Each of these components is described below. One of ordinary skill in the art will appreciate that embodiments are not limited to the configuration shown in FIG. 3.

In one or more embodiments, the data processing system 300 is configured to validate field data using the validation engine 302. The validation engine 302 may be a software component, a hardware component, or a combination of software and hardware. Validation engine 302 may be hosted on a data processing system located in the field at a well site, for example, or at a remote location. Validation engine 302 may be a software module incorporated into an existing software application usable for managing field operations.

In one or more embodiments, the validation engine 302 of the data processing system 300 is configured to receive field data 304. Field data 304 may be data derived from field operations. Field data 304 may be captured during the performance of any type of field operation. Field operations may include, for example, drilling operations, such as steering, advancing, or some other drilling activity at the wellsite. Field operations may also include, for example, acquiring and analyzing field data, modeling field data, managing existing fields, identifying production parameters, maintenance activities, wellsite exploration, recovery, or any other field operation. Validation engine 302 may receive field data 304 from wellsite 305. Wellsite 305 may correspond to the wellsite 200 as discussed with respect to FIG. 2. In particular, field data 304 may be received from collection devices (e.g., sensors at the wellsite 305) and from users, such as user 306.

User 306 may be, but is not limited to, a wellsite operator, a supervisor, or other employee or contractor present at the wellsite 305 or a remote location. User 306 may generate field data and/or receive field data collected from collection devices (e.g., sensors at the wellsite 305). In this case, user 306 may manually enter such generated and/or received field data 304 into the validation engine 302 using the interface 308.

Those skilled in the art will appreciate that field data 304 may be historical or current. Historical field data may be field data 304 that has been stored for use in field operations in the field data repository 318. Current field data may be field data 304 that is generated and collected from the field but has not been stored in the field data repository 318. Further, current field data and/or historical field data may be derived from the field, one or more fields proximate to the field, or some other field.

In one or more embodiments, field data 304 is submitted to validation engine 302 via a data entry form presented on interface 308. Interface 308 may be configured to enable validation engine 302 to communicate with other system components. Interface 308 may also be configured to permit communication with other field or non-field sources. In one or more embodiments, interface 308 receives field data 304 for processing. In addition, interface 308 may create data requests (for example surveys, logs, and risks) and may handle connection state events. Interface 308 may also display a graphical user interface for presenting information and notifications to user 306. The graphical user interface may be presented on the data processing system 300 hosting validation engine 302 or may be presented in a remote data processing system. The remote data processing system may be, for example, a personal digital assistant (PDA) in the possession of user 306, a laptop, or a desktop computer located remotely to validation engine 302.

In one or more embodiments, validation engine 302 validates field data 304 to verify that the integrity and accuracy of field data 304 before compilation and storage for subsequent use in analysis and reporting. In one or more embodiments, validation engine 302 is configured to validate field data 304 using validation rules stored in policy repository 310. In one or more embodiments, policy repository 310 is configured to be a repository for storing data. Policy repository 310 may be, for example, one or more databases, a directory service, one or more flat files, a spreadsheet, an extensible markup language (XML) file, or any other suitable data repository. Further, policy repository 310 may be a local storage device such as a hard disk drive or a remote storage device on a network. In particular, the validation rules stored in policy repository 310 may include data entry policy 312, validation policy 3 14, and data cleaning policy 316.

In one or more embodiments, data entry policy 312 is configured to contain a set of one or more rules governing the submission of field data 304 from a data generation source. The data generation source may be a source from which data is provided. The data generation source may include, but is not limited to, a user 306, or a data collection/distribution device. Validation engine 302 may be configured to reference the rules set forth by data entry policy 312 to identify facially valid field data and facially invalid field data from field data 304. In one or more embodiments, facially valid field data is data that satisfies the set of rules provided by data entry policy 312 and thus appears valid at the time of entry. For example, data entry policy 312 may include a rule specifying that field data 304 is received in a set of blank data entry fields of interface 308. Further, data entry policy 312 may specify at least one of a valid data entry format, a database constraint, and a range of data values. In other words, data entry policy 3 12 may specify either a valid data entry format, a database constraint, a range of data values, or any suitable combination thereof.

In one or more embodiments, data entry policy 312 is configured specify different sets of rules, depending upon the type of data entry form provided at interface 308. For example, the data entry form may be a set of blank fields that the data generation source populates with data as the data is captured from field data collection devices, or shortly thereafter. In this example, data entry policy 312 may specify rules that the field data entered into the data entry form are of a particular format, are in a predefined range, and satisfy database constraints. Additional rules may be included.

Examples of the rules of data entry policy 312 specifying the proper format in which field data 304 may be submitted include, but is not limited to, that temperature values be submitted in number format, names of wellsite operators be provided in letter format, and drilling equipment be provided as a combination of letters and numbers. Another rule may specify the number of characters that a particular field data entry may include.

Another rule of data entry policy 312 may specify an acceptable range of values for a particular field data entry field. For example, data entry policy 312 may include a rule providing that angles selected in degrees should be between −360 and +360, temperatures recorded in Kelvin should be between 0 and 999, and dollar amounts should not exceed the billion-dollar range.

Another rule of data entry policy 312 may require that field data values satisfy specified database constraints. Database constraints are limitations imposed to maintain the integrity of the database in which the submitted data is stored. Database constraints may include, for example, a primary key restraint, a uniqueness constraint, a not null constraint, a check constraint, foreign key constraint, or any other type of database constraint.

If validation engine 302 determines that a value of field data 304 is facially invalid, then validation engine 302 may reject the value and prompt the data generation source to provide a new value. Facially valid values of field data 304 are processed further by validation engine 302 using validation policy 314. Validation policy 314 is a set of one or more rules for dynamically validating facially valid values of field data 304. Dynamic validation is the processing of values of field data 304 using validation policy 314 in real time as the values are received from a data generation source, and the dynamic validation may occur after the initial determination is made as to whether the values are facially valid.

Alternatively, data entry policy 312 may specify that the submission of field data 304 is performed using a data entry form having data entry fields pre-populated with catalogued field data values. The catalogued field data values may be historical field data that have been captured during the performance of previous field operations. The data entry fields may be, for example, picklists or dropboxes presenting to a data generation source the field data values that may be selected. Thus, data entry policy 312 may provide that if a data entry field in a data entry interface requires a data generation source to provide a pipe diameter, then validation engine 302 may populate the data entry field with a list of pipe diameters used in previous field operations. The automatic population of the remaining data entry fields may be specified by validation policy 314, as provided below.

In one or more embodiments, field data values that have been provided in accordance with data entry policy 312 are subject to dynamic validation using the set of rules set forth in validation policy 314. Dynamic validation is validation of field data 304 in real-time, as the field data is received from a data generation source. In one or more embodiments, after the field data 304 is validated, the field data 304 is stored in the field data repository 318 for use in a field operation. Validation policy 314 may specify different rules depending upon the manner in which field data 304 is submitted. For example, where data entry policy 312 specifies that field data 304 is to be inputted in blank data entry fields of a data entry interface, validation policy 314 may require that the inputted field data values conform with a set of rules including, but not limited to, at least one of contextual validity rules, trend validity rules, and business validity rules. In other words, validation policy 314 may include contextual validity rules, trend validity rules, business validity rules, some other set of rules, or any suitable combination thereof.

In one or more embodiments, contextual validity rules verify field data based on physical properties associated with the field. Specifically, contextual validity rules are imposed to insure that the inputted field data values satisfy field operation guidelines and requirements. For example, field operation guidelines and requirements may dictate that a user inputting field data values into a data entry interface may not select a casing diameter that is larger than a wellbore because the casing would not be able to fit inside the wellbore. Similarly, temperatures may not be selected that would be hot enough to liquefy the drilling equipment. Contextual validity rules may be programmed individually and stored as a rule within validation policy 314. Alternatively, validation policy 314 may specify various knowledge bases, internal or external, that may provide the requisite contextual validity rules.

In one or more embodiments, trend validity rules are rules requiring that newly submitted values of field data 304 fit a pattern of current field data and historical field data. Historical field data may be field data collected during the performance of prior drilling operations. Over time, patterns of field data may be expected. For example, historical field data may specify an average amount of time required to drill a particular wellbore in any given earth formation, or the amount of drilling mud that may be required, an amount of money that may be spent, the number of personnel required to perform a job, or any other type of pattern. In one or more embodiments, values for field data 304 that are submitted and which are inconsistent with existing patterns derived from historical field data violate the trend validity rules of validation policy 314.

Trend validity may be determined with respect to a single variable analysis or a multiple variable analysis. For example, single variable trend analysis may be determined based upon a time variable or depth variable. Multi-variable trend analysis may consider correlations between variables, such as, for example, mud properties and drilling parameters. The trend validity may be determined using a Bayesian network analysis that predicts the evolution of key variables, such as mud properties and drilling parameters. This Bayesian network analysis may detect outlier field data values or data values that exceed a predefined tolerance, both of which violate trend validity rules specified by validation policy 314.

Those skilled in the art will appreciate that trend validity may be determined based on a variety of field data. For example, measurements of mud weight showing an increase in value may be monitored to verify that the measurements and the corresponding increase are consistent with predictive modeling for the field. In a related example, if measurements of mud weight at an offset well are available, the offset well measurements can be used to compare the consistency of measurements in mud weight for the field. In the case that the measurements of the mud weight at the field site are not consistent (e.g., growing at a much slower pace) with the corresponding measurements from the offset well, the inconsistency may indicate a variety of issues that should be addressed. Alternatively, if the inconsistency in the mud weights in this most recent example is due to an error in the manual entry of the mud weight measurements, then validation of the field data may notify a user of the error and provide suggestions for correcting the error before the comparison of the data with the offset well is performed.

In one or more embodiments, business validity rules are rules that specify the type of data that is required. For example, business validity rules may require that certain field data values be provided, whereas other field data values may be optionally provided. In addition, business validity rules may require various corporate policies to be satisfied. For example, business validity rules may require that a blowout prevention (BOP) test be performed every 14 days, that at least 2 safety meetings are conducted each day, that enough barite is provided to raise mud weight by 1 ppg in an active pit, that perforation is not to be performed at night, and that an employee identification number satisfies a particular format.

Validation policy 314 may also specify rules for dynamically validating field data inputted into a data entry form having data entry fields pre-populated with historical field data values selected from a catalogue. The catalogue may be, for example a database of previously validated field data. In this example, validation policy 314 may instruct validation engine 302 to restrict the display of field data values in subsequent data entry fields based upon previously selected field data entries. For example, if a user selects a particular piece of tubular piping having a specified outside diameter, then validation engine 302, referencing validation policy 314, may restrict the selection of a data entry field for inside diameters. Particularly, validation engine 302 may restrict inside diameters to those selections that are smaller than the outside diameter.

In one or more embodiments, data cleaning policy 316 is a set of rules and algorithms implemented to process invalid field data entries prior to compiling. Invalid field data entries may be those values of field data 304 that fail to comport with the set of rules set forth by validation policy 314. In one example, data cleaning policy 316 may provide one or more algorithms for smoothing otherwise invalid field data. Smoothing of field data is a technique implementing mathematical algorithms and logic for validating invalid field data values. In particular, data smoothing may be used to determine whether the invalidity of the field data values may be attributed to some form of system fault, such as malfunctioning data collection equipment. Data smoothing may transform invalid field data values into validated field data values. Examples of mathematical algorithms that may be used for data smoothing include, but are not limited to, random walk, moving average, simple exponential smoothing, Holt's method, and Winter's method. In addition, for invalid field data values that cannot be smoothed or otherwise validated, data cleaning policy 316 may specify that those invalid field data entries may be eliminated.

In one or more embodiments, processed field data is stored in field data repository 318. Field data repository 318 may be, for example, one or more databases, a directory service, one or more flat files, a spreadsheet, an extensible markup language (XML) file, or any other suitable data repository. Further, field data repository 318 may be a local storage device such as a hard disk drive or a remote storage device on a network. In this example, field data repository 318 includes validated field data 324, flagged field data 322, and best practices information 320. Validated field data 324 may be field data 304 whose values have been validated by validation engine 302 using validation policy 314. Validated field data 324 may be stored in a location for validated field data values. Similarly, flagged field data 322 may be field data 304 whose values have been deemed invalid by validation engine 302. Although in this example validated field data 324 and flagged field data 322 are depicted separately, validated field data 324 and flagged field data 322 may be stored in a common location.

In one or more embodiments, best practices information 320 is data describing best practices, tips, hints, suggestions, warnings, or other relevant data associated with field data 304. Entries of best practices information 320 may be hyperlinked with field data entries stored in validated field data 324 or flagged field data 322. Thus, for example, a user querying flagged field data 322 may retrieve from best practices information 320 additional information relating to an invalid field data entry of flagged field data 322. Likewise, a user querying best practices information 320 may be provided with related field data entries stored in validated field data 324 and/or flagged field data 322.

In one or more embodiments, validation engine 302 is configured to generate notifications 326 notifying selected users of potentially invalid field data that has been entered into interface 308. Notification 326 may be an audio and/or visual cue informing a selected user of the existence and consequences of particular field data values. For example, the visual cue may draw a user's attention to a recently entered field data value by highlighting the data entry field, changing the font, or changing the color of the questionable field data value. In addition, the visual cue may identify subsequent field data entry fields potentially affected by the invalid field data value. The visual cue may be accompanied by an audio cue, such as a computer generated sound, that also serves to notify user 306 of potentially invalid field data values.

Notification 326 may also be a report, such as report 328. Alternatively, report 328 may be provided in addition to notification 326. Report 328 is an electronic or paper document including information in the form of text and/or graphics. Report 328 may be generated to present to a user 306 validation information, including information relating to notification 326. When including information relating to notification 326, report 328 may indicate which validation rule of validation policy 314 has been violated. Report 328 may also indicate the consequences of accepting potentially invalid field data values, such as the effect on subsequent field operations. Report 328 may also suggest correct field data values.

Because field data 304 is collected from various sources, the possibility exists that field data values initially deemed valid may be rendered invalid by field data values received from a different source. In one or more embodiments, these invalid field data values are stored as flagged field data 322. Flagged field data 322 may be field data that requires additional processing. In one example, the additional processing is a global validation operation. The global validation operation may be a process for validating flagged field data values using validation policy 314. In particular, a selected user may be presented with a list of flagged field data values. The list may be presented to a user in a report, such as report 328. In addition, each field data value in the list may be hyperlinked to a different report page providing additional information relating to the flagged field data value. The additional information may identify a validation rule violated by the listed field data value, or another field data entry conflicting with the listed field data value.

Upon receiving the list of flagged field data values, a user 304 may enter corrected field data values in place of the flagged field data values. As the corrected field data values are entered, validation engine 302 may validate the corrected field data values using validation policy 3 14. If validation engine 302 is still unable to validate the corrected field data value, then validation engine 302 may prompt the user for a new entry or may attempt to smooth the field data entry according to the rules set forth in data cleaning policy 316. Validated field data values may be incorporated into validated field data 324. Field data values incapable of validation may remain in flagged field data 322. In addition, the invalid field data values may be stored with additional information detailing the validity rules that were violated, other field data values that may render the field data value invalid, or any other information related to the invalid field data values.

Validation engine 302 may initiate the global validation operation automatically or according to some predefined event. The event may be, for example, a set schedule requiring validation engine 302 to perform the global validation operation on a particular day, after a particular step of a drilling operation has been completed, or upon receiving a request from a user prior to compiling the field data values for storage and processing.

Data processing system 300 includes field data processing engine 330. In one or more embodiments, field data processing engine 330 is configured to process validated field data 324. In particular, field data processing engine 330 may be configured to manipulate and interact with validated field data 324. For example, a user may operate field data processing engine 330 to plan a prospective well using validated field data 324. In this example, field data processing engine 330 may be used for performing offset well analysis. In one or more embodiments, offset well analysis is the analysis of wells having characteristics similar to a prospective well. Analysis of offset wells may permit a user to identify casing profiles, expected events correlating with a planned drilling trajectory, determine necessary mud weight, estimate a time for completion of the prospective wellsite operation, identify non-productive time, select proper equipment, and perform the wellsite operation according to the technical limit.

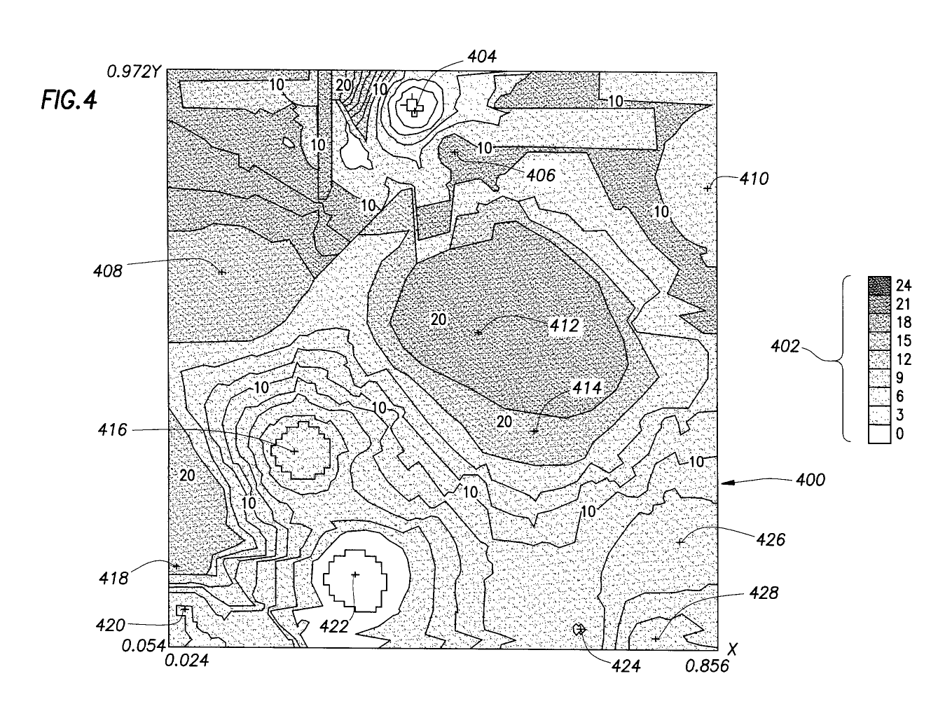

In one or more embodiments, field data processing engine 330 is configured to include processing engine interface 332. Processing engine interface 332 may be configured to present information to a user. The information may include prospective well report 334. In one or more embodiments, prospective well report 334 is a report providing the information identified from offset well analysis, as described above. For example, prospective well report 334 may include a contour map, such as contour map 400 as described with respect to FIG. 4.

Field data processing engine 330 may be a software component, a hardware component, or a combination of hardware and software. In addition, field data processing engine 330 may be hosted in a location remote from validation engine 302. For example, validated field data 324 may be transmitted offsite for long-term storage. The offsite location may include remote data processing systems hosting field data processing engine 330. In the instance where field data processing engine 330 is entirely a software component, field data processing engine 330 may be incorporated into existing software applications for managing field operations.

While specific components are depicted and/or described for use in the units and/or modules of the data processing system 300, it will be appreciated that a variety of components with various functions may be used to provide the formatting, processing, utility and coordination functions necessary validating field data in the data processing system 300. The components may have combined functionalities and may be implemented as software, hardware, firmware, or combinations thereof.

FIG. 4 is a schematic diagram depicting a contour map for presenting selected field data. Contour map 400 may be presented to a user. Contour map 400 may then be used to identify locations for drilling prospective wellsites based upon historical data that has been previously dynamically validated as the field data was received from a data generation source. Contour map 400 may show different gradations with varying colors, shading, some other form of differentiation, or any combination thereof.

Contour map 400 includes scale 402 and offset wells 404, 406, 408, 410, 412, 414, 416, 418, 420, 422, 424, 426, and 428. In this example, scale 402 includes gradations associated with varying degrees of a selected field parameter. The field parameters may include, for example, risk, events, loss, time, cost, length, depth, bit, or any other parameter associated with a wellsite and/or field parameter.

In this example, contour map 400 is an iso-event map that depicts occurrences of undesirable events. Undesirable events are any events that may negatively impact a wellsite operation. Undesirable events may include, for example, broken drillbits, delayed drilling schedules due to inaccessibility, seismic or weather-related events, or any other event related to performance of drilling operations. Thus, scale 402 may depict, for example, the number of undesirable events that occurs over a selected period of time. The lightest shading gradation of scale 402 corresponds with the lowest occurrence of undesirable events. The darkest shading gradation of scale 402 corresponds with the highest occurrence of undesirable events. Each gradation is assigned a value or range of values, which corresponds to contours of contour map 400. Thus, areas of contour map 400, which have the least number of undesirable events occurring, are areas that prospective wellsites may be optimally located. In contour map 400, offset wells 404, 416, 422, and 428 are located in areas having the lowest occurrence of undesirable events.

Multiple contour maps may be generated and overlaid to identify locations that satisfy any number of selected field parameters. Thus, a contour map depicting, for example, the highest yield of hydrocarbons overlaid with contour map 400 depicting the lowest occurrence of undesirable events may allow a user to plan the drilling of a prospective wellsite in a location having the highest yield of hydrocarbons and the least likelihood of encountering undesirable events.

Contour maps may be based on, for example, an isorisk property, an isoloss property, an isostuck property, an isotime property, an isocost property, an isolength property, an isodeep property, an isobit property, or an isocasing property. Isorisk may relate to an amount of risk for an area in terms of non-productive time. Isoloss may relate to an amount of mud losses in one or more wells. Isostuck may relate to a probability of a pipe getting stuck in a hole. Isotime may relate to an amount of time required to drill a well. Isocost may relate to an amount of money required to drill a well. Isolength may relate to a final depth of a well (i.e., the measured depth). Isodeep may relate to a final depth of a well (i.e., the true vertical depth). Isobit may relate to a number of drill bits required to drill a well. Isocasing may relate to the number of casing strings required to complete a well.

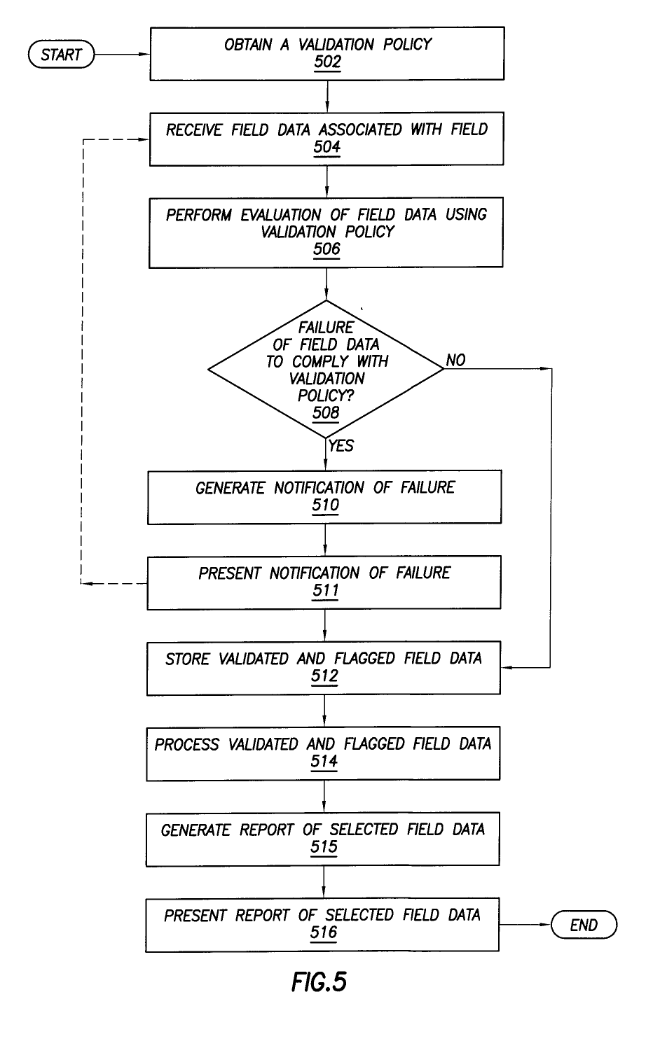

FIG. 5 is a flowchart of a process for processing field data captured during the performance of drilling operations. One or more of the blocks shown in FIG. 5 may be omitted, repeated, and/or performed in a different order than that shown in FIG. 5. In addition, a person of ordinary skill in the art will appreciate that other blocks, omitted in FIG. 5, may be included in one or more of these flowcharts. Accordingly, the specific arrangement of blocks shown in FIG. 5 should not be construed as limiting the scope of validating field data.

The process begins by obtaining a validation policy (block 502). The validation policy may include, for example, data entry policies such as data entry policy 312 of FIG. 3, business validity rules, trend validity rules, and/or contextual validity rules.

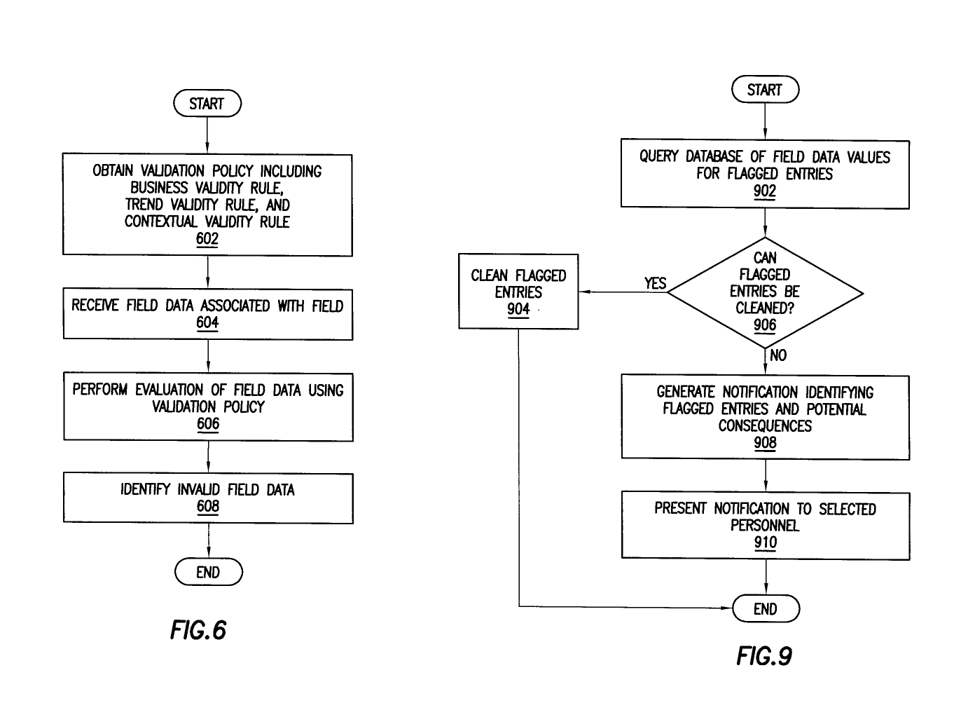

Field data associated with the field (e.g., data associated with wellsite 305 in FIG. 3) is received (block 504). Subsequently, an evaluation of the field data is performed using the validation policy (block 506). More detail of the evaluation in block 506 is described in more detail with respect to FIG. 6 below. During the evaluation of block 506, a determination is made as to whether the field data fails to comply with the validation policy (block 508). If the field data fails to comply with the validation policy, then a notification of the failure is generated (block 510).

The notification of the failure is then presented (block 511). In response to receiving the notification, a user may have the option to resubmit field data (block 504) to replace the invalid field data. The process then proceeds to block 512.

The validated and flagged data is stored (block 512). The validated and flagged field data is then processed (block 514). Once processed, a report of selected field data is generated (block 515), and then presented. The processing and presentation of the validated field data may then be used to generate results for managing a reservoir. The results may, for example, identify drill times, areas where oil and gas may be found, locations where undesirable events occur, or other results that may be pertinent for managing a reservoir. The management of reservoirs may include the performance of any task associated with reservoir operations. The reservoir operations may include, for example, planning, maintenance, surveying, or any other task.

FIG. 6 illustrates a flowchart for performing an evaluation of the field data using the validation policy. One or more of the blocks shown in FIG. 6 may be omitted, repeated, and/or performed in a different order than that shown in FIG. 6. In addition, a person of ordinary skill in the art will appreciate that other blocks, omitted in FIG. 6, may be included in one or more of these flowcharts. Accordingly, the specific arrangement of blocks shown in FIG. 6 should not be construed as limiting the scope of validating field data.

The evaluation of the field data is performed when the field data associated with a field is received from a data generation source. The evaluation begins by obtaining a validation policy associated with the field, where the validation policy includes a business validity rule, a trend validity rule, and a contextual validity rule (block 602). The field data may be pre-processed according to a data entry policy before undergoing the evaluation using the validation policy described in block 602. The evaluation then receives the field data associated with a field (block 604).

Thereafter, the evaluation of the field data is performed using the validation policy (block 606). Dynamic validation of the field data values occurs in real time, upon receipt of the field data. In one or more embodiments, the validation policy corresponds to the validation policy 314 as described with respect FIG. 3 above.

Invalid field data is then identified (block 608). Identification of the invalid field data values may be achieved by flagging invalid field data entries. The flag may be any form of identifier capable of distinguishing the invalid field data entries from the validated field data entries.

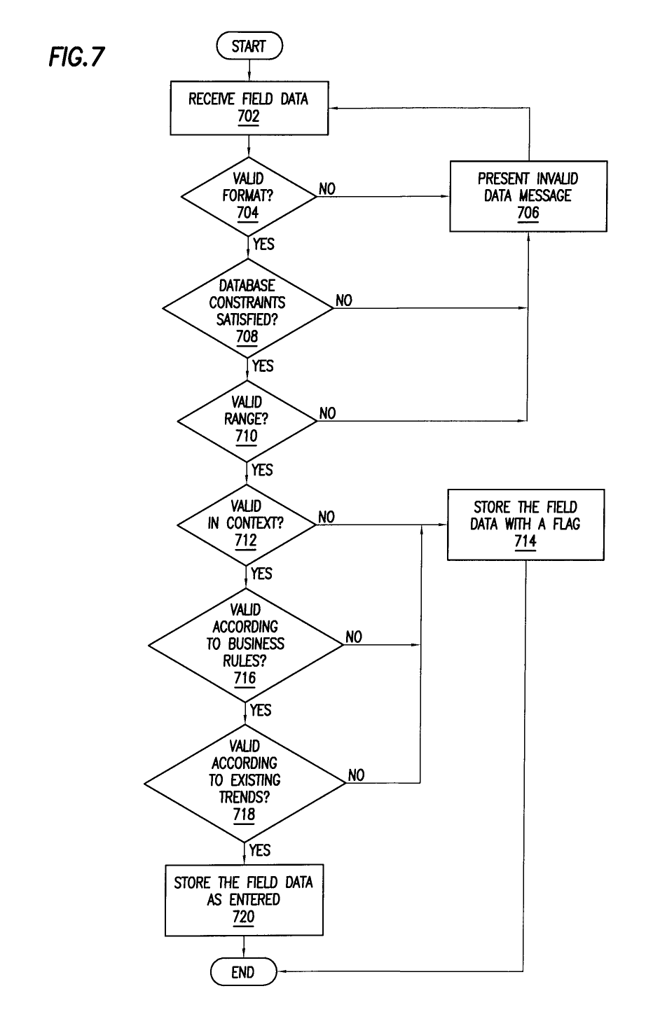

FIG. 7 illustrates a flowchart for validating field data values submitted in a blank data entry field of a data entry interface. One or more of the blocks shown in FIG. 7 may be omitted, repeated, and/or performed in a different order than that shown in FIG. 7. In addition, a person of ordinary skill in the art will appreciate that other blocks, omitted in FIG. 7, may be included in one or more of these flowcharts. Accordingly, the specific arrangement of blocks shown in FIG. 7 should not be construed as limiting the scope of validating field data.

The validation operation begins by receiving field data (block 702). A determination is then made as to whether the field data values are in a valid format (block 704). If the field data values are in a valid format (i.e., an invalid format), then an invalid data message is presented (block 706), and the process returns to block 702. If the field data values are in a valid format, then the process proceeds to block 708.

In block 708, a determination is made as to whether the field data values satisfy database constraints. If the field data values fail to satisfy database constraints, then the process proceeds to block 706. If the field data values satisfy database constraints, then the process proceeds to block 710. In block 710, a determination is made as to whether the field data values are within a valid range. If the field data values are not within a valid range, then the process proceeds to block 706. If the field data values are within a valid range, then the process proceeds to block 712.

In block 712, a determination is made as to whether the field data values are valid in context. The determination in block 712 is made using one or more contextual validity rules. A contextual validity rule may verify the field data based on field operation guidelines and requirements. For example, a newly drilled hole is smaller than the last casing, except when using a hole opener tool. In some embodiments, a contextual validity rule may involve multiple variables. If the field data values are not valid in context, then the field data is stored with a flag (block 714), and the validation operation terminates thereafter. If the field data values are valid in context, then the process proceeds to block 716.

In block 716, a determination is made as to whether the field data values are valid according to business rules (block 716). The determination in block 716 is made using one or more business validity rules. A business validity rule may specify a type of field data required for the field operation. Further, a business validity rule may be related to field data or a regulation. For example, a business validity rule related to a regulation may specify that at least two safety meetings are held every day or that perforations of the well may not occur at night. If the field data values are not valid according to business rules, then the process returns to block 714. If the field data values are valid according to business rules, then the process proceeds to block 718.

In block 718, a determination is made as to whether the field data values are valid according to existing trends of historical field data. The determination in block 718 is made using one or more trend validity rules. A trend validity rule may verify the field data based on a pattern of historical field data. A trend validity rule may be based on the trend of a single variable or a multiple of variables. Examples of a trend of a single variable may include, but is not limited to, a trend based on time or a trend based on depth. For multiple-variable trend analysis, a Bayesian analysis may be used. An example of a multiple-variable trend analysis is correlating between mud properties and drilling parameters. If the field data values are not valid according to existing trends, then the process continues to block 714. If the field data values are valid according to existing trends, then the field data is stored as entered (block 720). The stored field data values may be stored as validated field data such as the validated field data 324 as described with respect FIG. 3 above.

In this validation operation depicted in FIG. 7, blocks 704 through 710 are blocks for evaluating the field data using a set of data entry policies such as data entry policy 312 as described with respect FIG. 3 above. In addition, blocks 712 through blocks 720 of FIG. 7 are blocks for dynamically validating the field data using a validation policy such as the validation policy 314 as described with respect FIG. 3 above.

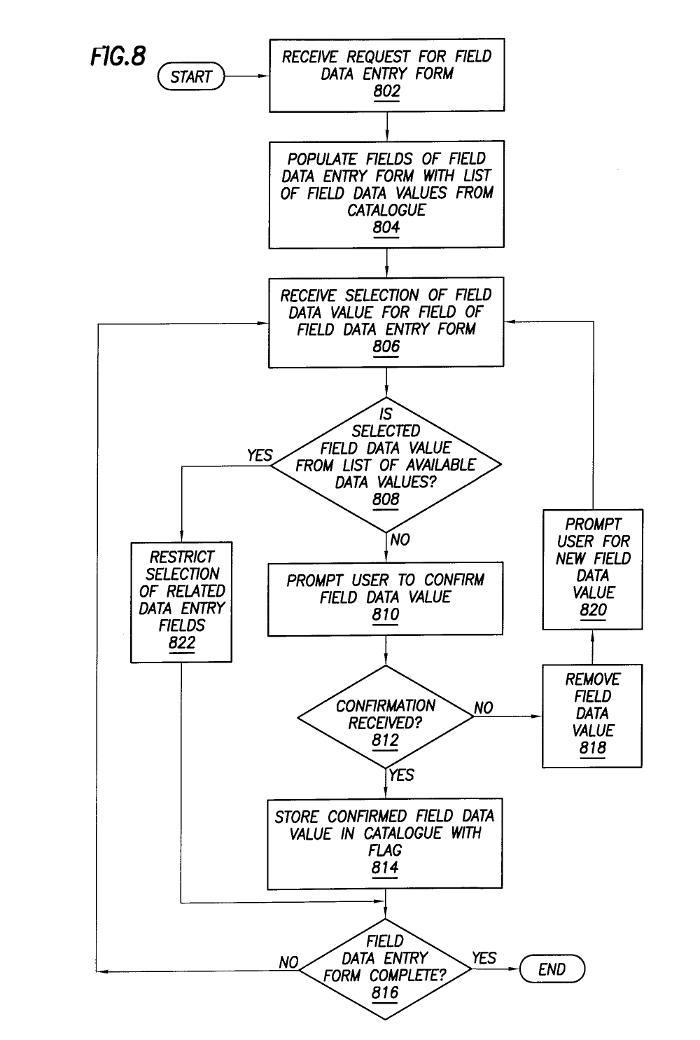

FIG. 8 illustrates a flowchart for validating field data values submitted via selection of field data values from a list of catalogued field data values. The list of catalogued field data values may be populated into data entry fields of a data entry form and automatically restricted based upon a selection of other field data values. One or more of the blocks shown in FIG. 8 may be omitted, repeated, and/or performed in a different order than that shown in FIG. 8. In addition, a person of ordinary skill in the art will appreciate that other blocks, omitted in FIG. 8, may be included in one or more of these flowcharts. Accordingly, the specific arrangement of blocks shown in FIG. 8 should not be construed as limiting the scope of validating field data.

Initially, a field data entry form is requested (block 802). The field data entry form may be requested by a user or a data entry collection device. Data entry fields of the field data entry form are then populated with a list of field data values derived from a catalogue of field data values (block 804). The catalogue of field data values may be field data values that have been previously validated.

Thereafter, a selection of a field data value for a data entry field of the field data entry form is received (block 806). A determination is then made as to whether the selected field data value is from the list of available field data values (block 808). If the selected field data value is not from the list of available field data values, then the user is prompted to confirm the field data value (block 810), and the process proceeds to block 812. The user may be any data generation source, as previously described with respect to FIG. 3. If the selected field data value is from the list of available field data values, then the selection of related data entry fields is restricted (block 822), and the process proceeds to block 816.

In block 812, a determination is made as to whether confirmation of the field data value has been received. If confirmation of the field data value has been received, then the confirmed field data value is stored in the catalogue with a flag (block 814), and the process proceeds to block 816. If confirmation of the field data value has not been received, then the field data value is removed (block 818). After block 818, the user is prompted for a new field data value (block 820), and the process proceeds to block 806.

In block 816, a determination is made as to whether the field data entry form is complete. If the field data entry form is complete, then the validation operation terminates thereafter. If the field data entry form is not complete, then the process proceeds to block 806.

FIG. 9 illustrates a flowchart of a process for generating a notification to alert selected personnel of the existence of invalid field data values. One or more of the blocks shown in FIG. 9 may be omitted, repeated, and/or performed in a different order than that shown in FIG. 9. In addition, a person of ordinary skill in the art will appreciate that other blocks, omitted in FIG. 9, may be included in one or more of these flowcharts. Accordingly, the specific arrangement of blocks shown in FIG. 9 should not be construed as limiting the scope of validating field data.

Initially, a database of field data values is queried for flagged entries (block 902). A determination is then made as to whether the flagged field data entries can be cleaned (block 904). If the flagged field data entries can be cleaned, then the flagged entries are cleaned (block 906), and the process terminates thereafter. If the flagged field data entries cannot be cleaned, then a notification identifying the flagged field data entries and the potential consequences of accepting the flagged field data entries is generated (block 908). The notification is then presented to selected personnel (block 910), and the process terminates thereafter.

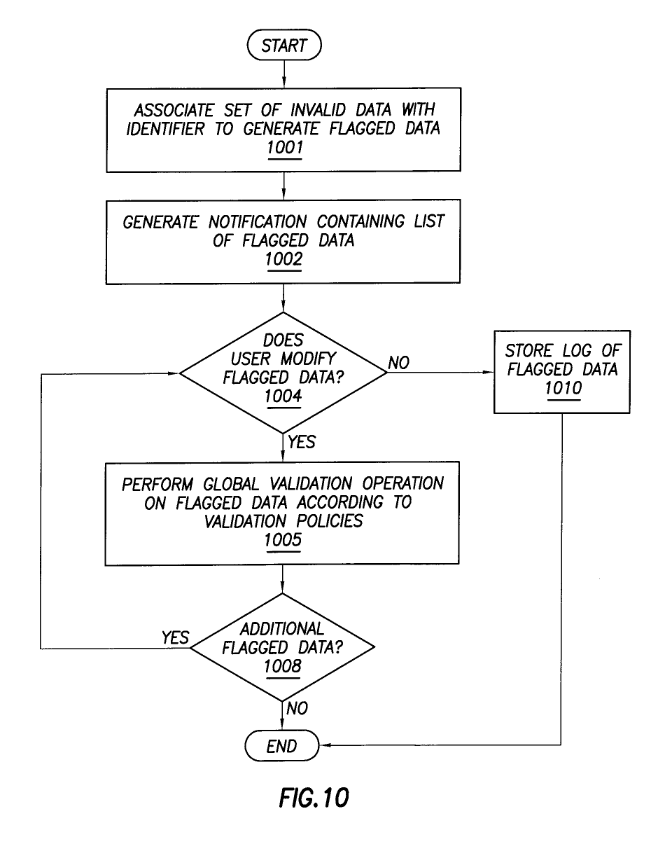

FIG. 10 illustrates a flowchart of a process for performing a global validation of flagged field data values. The process may be performed at any point prior to storing the field data for use in subsequent field operations, such as analysis and report generation. One or more of the blocks shown in FIG. 10 may be omitted, repeated, and/or performed in a different order than that shown in FIG. 10. In addition, a person of ordinary skill in the art will appreciate that other blocks, omitted in FIG. 10, may be included in one or more of these flowcharts. Accordingly, the specific arrangement of blocks shown in FIG. 10 should not be construed as limiting the scope of validating field data.

Initially, a set of invalid data is associated with an identifier to generate flagged data (block 1001). A notification containing a list of flagged data is then generated (block 1002). The notification may be presented to selected personnel in a report. A determination is then made as to whether a user modifies the flagged data (block 1004). If the user modifies the flagged data, then a global validation operation is performed on the flagged data (block 1005). In particular, the modified flagged data may be evaluated according to validation policies. If the user does not modify the flagged data, then a log of the flagged data is stored (block 1010), and the process ends. The log may be a database of flagged field data values.

After block 1005 a determination is then made as to whether additional flagged data exists (block 1008). If additional flagged data exists, then the process returns to block 1004. If additional flagged data does not exist, then the process terminates.

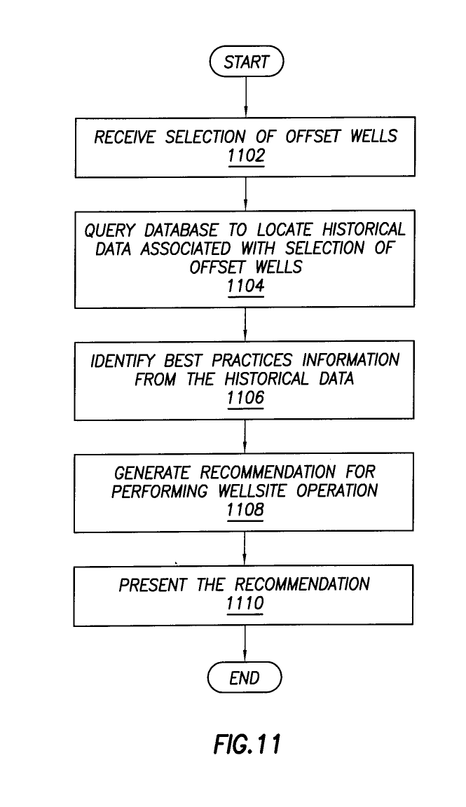

FIG. 11 illustrates a flowchart of a process for planning a wellsite operation using historical field data. One or more of the blocks shown in FIG. 11 may be omitted, repeated, and/or performed in a different order than that shown in FIG. 11. In addition, a person of ordinary skill in the art will appreciate that other blocks, omitted in FIG. 11, may be included in one or more of these flowcharts. Accordingly, the specific arrangement of blocks shown in FIG. 11 should not be construed as limiting the scope of validating field data.

Initially, a selection of offset wells is received (block 1102). The set of offset wells are selected according to similarities with a prospective well of the wellsite operation. A database is then queried to locate historical data associated with the selection of offset wells (block 1104). For example, the historical data may include a number of undesirable events that occur in a particular location, mud weight, drill time, or any other data that may be extracted from an offset well.

Best practices information is then identified from the historical data (block 1106). A recommendation for performing a wellsite operation is then generated based on the best practices information (block 1108). The recommendations for drilling the prospective well may include best practices or lessons learned, as previously described. The recommendation is then presented (block 1110), and the process ends.

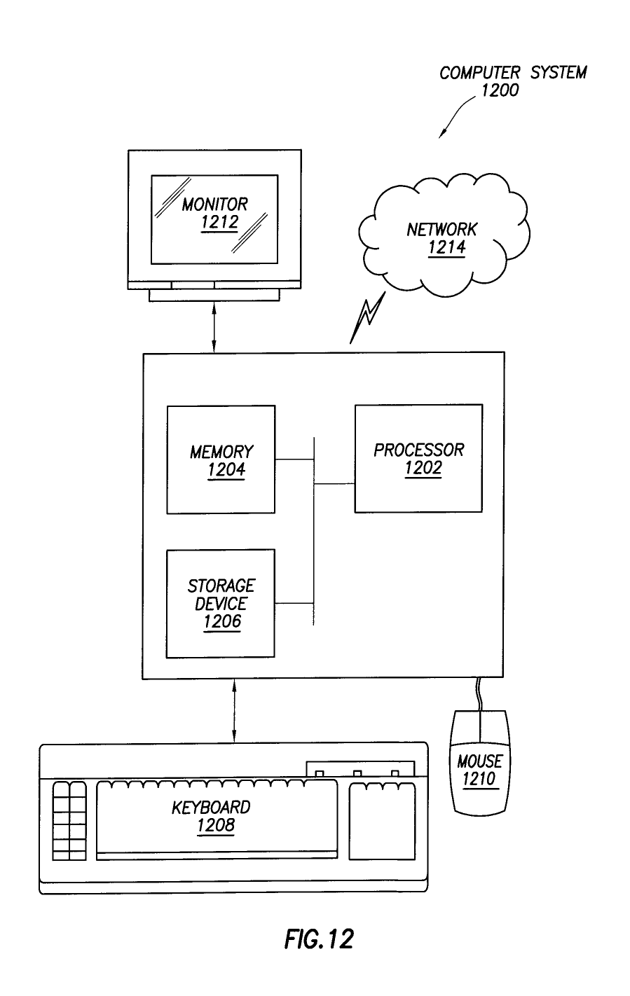

Embodiments of validating field data may be implemented on virtually any type of computer regardless of the platform being used. For instance, as shown in FIG. 12, a computer system 1200 includes one or more processor(s) 1202, associated memory 1204 (e.g., random access memory (RAM), cache memory, flash memory, etc.), a storage device 1206 (e.g., a hard disk, an optical drive such as a compact disk drive or digital video disk (DVD) drive, a flash memory stick, etc.), and numerous other elements and functionalities typical of today's computers (not shown). The computer 1200 may also include input means, such as a keyboard 1208, a mouse 1210, or a microphone (not shown). Further, the computer 1200 may include output means, such as a monitor 1212 (e.g., a liquid crystal display LCD, a plasma display, or cathode ray tube (CRT) monitor). The computer system 1200 may be connected to a network 1214 (e.g., a local area network (LAN), a wide area network (WAN) such as the Internet, or any other similar type of network) via a network interface connection (not shown). Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means may take other forms, now known or later developed. Generally speaking, the computer system 1200 includes at least the minimal processing, input, and/or output means necessary to practice one or more embodiments.

Further, those skilled in the art will appreciate that one or more elements of the aforementioned computer system 1200 may be located at a remote location and connected to the other elements over a network. Further, one or more embodiments may be implemented on a distributed system having a plurality of nodes, where each portion of the implementation (e.g., the validation engine, the policy repository) may be located on a different node within the distributed system. In one or more embodiments, the node corresponds to a computer system. Alternatively, the node may correspond to a processor with associated physical memory. The node may alternatively correspond to a processor with shared memory and/or resources. Further, software instructions to perform one or more embodiments may be stored on a computer readable medium such as a compact disc (CD), a diskette, a tape, or any other computer readable storage device.

The systems and methods provided relate to the acquisition of hydrocarbons from an oilfield. It will be appreciated that the same systems and methods may be used for performing subsurface operations, such as mining, water retrieval and acquisition of other underground materials. Further, portions of the systems and methods may be implemented as software, hardware, firmware, or combinations thereof.

While validating field data has been described with respect to a limited number of embodiments, those skilled in the art, having benefit of this disclosure, will appreciate that other embodiments may be devised which do not depart from the scope as disclosed herein. Accordingly, the scope should be limited only by the attached claims.

What is claimed is:

1. A method for validating field data associated with a field having a plurality of wellsites, the method comprising:
obtaining a validation policy associated with the field, the validation policy comprising a business validity rule, a trend validity rule, and a contextual validity rule for verifying the field data based on field operation guidelines;
receiving the field data associated with the field;
prior to storing the field data for use in a field operation:
evaluating the field data using the validation policy,
during the evaluation, identifying a failure of the field data to comply with the validation policy,
generating, using the failure, a set of invalid data that violates at least the field operation guidelines, and
generating a notification of the failure; and
presenting the notification of the failure and the set of invalid data.

2. The method of claim 1, wherein:
the field data is received in a set of blank data entry fields of a data entry interface; and
the validation policy further comprising a valid data entry format, a database constraint, and a range of data values.

3. The method of claim 1, wherein:
the business validity rule specifies a type of field data required for the field operation,
the trend validity rule verifies the field data based on a pattern of current field data and historical field data, and
the field operation guidelines describe physical properties associated with the field.

4. The method of claim 1, wherein the trend validity rule verifies the field data by analyzes the correlation of variables associated with the field operation.

5. The method of claim 1, wherein the field data is received as a first field data value in a first data entry field, and wherein the validation policy automatically populates a set of data entry fields of a data entry interface based upon the selection of the first field data value.

6. The method of claim 1, wherein presenting the notification of the failure further comprises presenting a potential cause of the failure.

7. The method of claim 1 further comprising:
associating the set of invalid data with an identifier to generate flagged data; and
performing a global validation operation on the flagged data.

8. The method of claim 1, further comprising:
generating a contour map based on the evaluation, the contour map comprising selected report parameters comprising at least one of group consisting of an isorisk property, an isoloss property, an isostuck property, an isotime property, an isocost property, an isolength property, an isodeep property, an isobit property, and an isocasing property; and
presenting the contour map.

9. The method of claim 1, further comprising:
presenting recommended drilling operations based on evaluating the field data.

10. The method of claim 1, further comprising:
receiving a selection of offset wells responsive to receiving the selection of offset wells, querying a database to locate historical data associated with the selection of offset wells;
identifying best practices information from the historical data, wherein the best practices information is generated during a dynamic validation of the field data as the field data is received from a data generation source;
generating a recommendation for performing a wellsite operation, wherein the recommendation identifies selected drilling parameters; and
presenting the recommendation.

11. The method of claim 10, wherein the selection of offset wells is selected from a contour map.

12. A computer readable medium comprising instructions executable by a processor to perform a method for validating field data associated with a field having a plurality of wellsites, the instructions comprising functionality for:
receiving the field data associated with the field;
in response to receiving the field data and prior to storing the field data for use in a field operation:
performing a validation of the field data to generate a validated set of data, the validation comprising:
verifying that the field data conforms to a business validity rule associated with the field;
verifying that the field data conforms to a trend validity rule associated with the field;
verifying that the field data conforms to a contextual validity rule associated with the field; and
generating the validated set of data based on the field data conforming to the business validity rule, the trend validity rule, and the contextual validity rule;
generating a notification of the field data validation; and
presenting the notification of the field data validation and the validated set of data.

13. The computer readable medium of claim 12, the validation further comprising:
verifying that the field data is of a valid format;
verifying that the field data satisfies database constraints; and
verifying that the field data is of a valid range.

14. The computer readable medium of claim 12, wherein:
the business validity rule specifies a type of field data required for the field operation,
the trend validity rule verifies the field data based on a pattern of current field data and historical field data, and
the contextual validity rule verifies the field data based on field operation guidelines, the field operation guidelines describing physical properties associated with the field.

15. The computer readable medium of claim 12, the instructions further comprising functionality for:
generating recommended drilling operations based on the validated set of field data; and
presenting the recommended drilling operations.

16. A system for validating field data associated with a field having a plurality of wellsites, the system comprising:
a policy repository configured to provide a validation policy, the validation policy comprising a business validity rule, a trend validity rule, and a contextual validity rule;
a field data repository configured to store the field data and a set of invalid data;
a field data processing engine configured to process the field data stored in the field data repository for use in evaluating the field; and
a validation engine comprising a user interface for receiving the field data, the validation engine configured, prior to storing the field data in the field data repository, to:
evaluate the field data using the validation policy,
during the evaluation, identify a failure of the field data to comply with the validation policy,
generate, using the failure, the set of invalid data that violates at least the field operation guidelines,
generate a notification of the failure, and
present the notification of the failure and the set of invalid data.

17. The system of claim 16, wherein:
the business validity rule specifies a type of field data required for the field operation,
the trend validity rule verifies the field data based on a pattern of current field data and historical field data, and
the contextual validity rule verifies the field data based on field operation guidelines, the field operation guidelines describing physical properties associated with the field.

18. The system of claim 16, wherein the field data repository is further configured to store validated field data, best practices information, and flagged field data.

19. The system of claim 16, wherein the policy repository is further configured to store a data entry policy, the validation policy, and a data cleaning policy.

20. The system of claim 16, wherein the validation engine is further configured, prior to storing the field data in the field data repository, to present recommended drilling operations based on evaluating the field data.
